(19) United States
(12) Patent Application Publication
(10) Pub. No.: US 2008/0166119 A1
(43) Pub. Date: Jul. 10, 2008

(54) Optical network unit for error detection and recovery of optic module and control method thereof

(75) Inventors: Jae-Hwang Ryu, Suwon-si (KR); Hong-Gi Lee, Yongin-si (KR); Soon-Ho Jang, Yongin-si (KR); Jung-Hwan Lim, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/893,266

(22) Filed: Aug. 15, 2007

(30) Foreign Application Priority Data
Jan. 5, 2007 (KR) 2007-0001451

(51) Int. Cl. H04B 10/08

(52) U.S. Cl. 398/17

(57) ABSTRACT

An optical network unit for error detection and recovery of an optical module, and a control method thereof are provided. The optical network unit includes a passive optical network medium access control (PON MAC) to output an optical output control signal to activate a laser diode in a time slot allocated to the optical network unit, a monitor photo diode (PD) to sense whether the laser diode outputs an optical signal and generate a feedback signal and an error detection controller to determine whether optical signal output operation is abnormal by comparing the optical output control signal with the feedback optical signal and interrupting power to at least said laser diode when abnormal operation is determined.

### CLAIM OF PRIORITY

This application claims the benefit of the earlier filing date, under 35 U.S.C. §119(a), to that patent application entitled “OPTICAL NETWORK UNIT FOR ERROR DETECTION AND RECOVERY OF OPTIC MODULE AND CONTROL METHOD THEREOF” filed in the Korean Intellectual Property Office on Jan. 5, 2007 and assigned Serial No. 2007-0001451, the entire contents of which are hereby incorporated herein by reference.

### BACKGROUND OF THE INVENTION

1. Field of the Invention

The present invention relates to an optical network unit and more particularly to for error detection and recovery of an optical module in an optical network unit.

2. Description of the Related Art

The internet has fundamentally changed a network environment. As a user's demand for higher speed and quality of data increases, an associated market rapidly becomes larger. This large market has been created by a popularized asymmetric digital subscriber line (ADSL) that uses the existing copper wire and provides a high-speed internet service. However, even the high speed of the ADSL does not satisfy a user's demand. Accordingly, a passive optical network (PON) has been proposed as an alternative to the ADSL.

The PON provides a high-speed data service based on an optical fiber to an enterprise, a small office home office (SOHO), and a home. In the PON having a typical structure, an optical line termination (OLT) is installed at a central office (CO); and a plurality of optical network units (ONU) are connected to the single OLT through an optical star coupler of “1:n.” Here, the ONU either converts an optical signal into an electrical signal or converts an electric signal into an optical signal.

In a time-division multiplexing (TDM)-based PON, the respective units share an optical line with one another. Here, the respective units output optical signals at a preset or allowed time so that they can transmit and receive data through the shared optical line without interference. If even one unit outputs the optical signal at a disallowed time, it may have a fatal effect on all units sharing the same line. To solve this problem, some conventional methods employ detecting or controlling a laser's on/off period. Operation of a general TDM-based optical network will now be described.

FIG. 1 is a block diagram of a general TDM-based optical network.

As shown in FIG. 1, the TDM-based optical network includes an OLT 30, a splitter 20 and a plurality of ONUs 11, 12, 13 and 14. Substantially, many other elements are included in the TDM-based optical network, but they are not illustrated in FIG. 1 for convenience of illustration.

The OLT 30 is part of the optical network that corresponds to an optical termination equipment of a service provider. The OLT 30 serves as a multi-service device for connecting an optical subscriber network with another system. The OLT 30 includes a service interface and protocol processing (SIPP) device, a cable network device, a transmission device and a network management device, and has functions of a connection with a local switch (LS) using common channel signaling (CCS) and channel associated signaling (CAS) in a public switched telephone network (PSTN) and an integrated service digital network (ISDN); an interface in a packet switching public data network (PSPDN); etc.

Each of the ONUs 11, 12, 13 and 14 is a network termination apparatus to access the optical subscriber network for the next generation network. The ONU 11, 12, 13 or 14 is installed in a subscriber's home, and converts a video interface or a communication interface, such as a user-network interface of a narrowband integrated service digital network (N-ISDN), a user-network interface of a broadband integrated service digital network (B-ISDN), etc., thereby accessing a fiber optic network.

The splitter 20 is a device that receives one optical signal and divides it into a plurality of optical signals. Splitter 20 includes an input light guide core (not shown) connected to an input optical fiber block having an input optical fiber, and a plurality of output light guide cores (not shown) branched from the input light guide core.

FIG. 1 shows that the plurality of ONUs 11, 12, 13 and 14 uplink-transmit data for their respective allocated times. Each of first, second, third and fourth ONUs 20 transmits the data in its own allocated time. In FIG. 1, IDs of the data transmitted at the allocated time are illustrated as 1, 4, 3 and 2, respectively. Although the data is transmitted to the OLT 30 through the splitter 20, there is no interference between the optical signals transmitted from the splitter 20 to the OLT 30 because the data having the IDs of 1, 4, 3 and 2 is not transmitted at the same time. Such a system, where the plurality of ONUs 11, 12, 13 and 14 transmit the data during the times allocated thereto, respectively, is referred-to as time division multiplexing (TDM).

FIG. 2 is a block diagram illustrating a malfunction of a general time-division multiplexing based optical network.

As shown in FIG. 2, the third ONU 13 uplink-transmits the data at a time not allocated thereto. In FIG. 2, the data of ID3 is relatively long to denote that the third ONU 13 transmits data in a time slot not allocated to the third ONU 13.

One of the reasons why the third ONU 13 uplink-transmits the data in a time slot not allocated thereto is that an error is generated in an optical module of the third ONU 13. In this case, the optical module erroneously outputs the optical signal even though an activating signal is not applied to a laser diode of the optical module.

The above-described error of the optical module is generated in only the third ONU 13, but it causes a critical error in transmission of the other ONUs, i.e., the second and fourth ONUs 12 and 14. The third ONU 13 uplink-transmits the data for the time allocated to the second and fourth ONUs 12 and 14, and the data from the third ONU 13 interferes with normal optical signals from the second and fourth ONUs 12 and 14. Consequently, the third ONU 13, having the erroneous optical module, causes malfunction of the whole optical network.

FIG. 3 is a block diagram showing a general TDM-based optical network unit.

A general optical network unit (ONU) 10 has an uplink data transmission structure that includes a passive optical network medium access control (PON MAC) unit 15, a laser diode (LD) driver 16, and an LD module 17.

The PON MAC unit 15 transmits the data to the LD driver 16 before transmitting it to the OLT 30 (FIG. 1). Further, the ONU 10 transmits the optical signal to the OLT 30 using TDM, so that the PON MAC unit 15 transmits a laser enable signal to the LD driver 16 in order to activate a laser diode 18 for the time allocated thereto.

The LD driver 16 generally controls the output of the laser diode 18. The LD driver 16 receives an optical output control signal and a data signal through a laser enable terminal and “In+” and “In−” terminals from the PON MAC unit 15, respectively. Further, the LD module 17 uses the laser diode 18 to physically generate an optical signal.

A general ONU 10 employs a method of measuring and controlling the optical output control signal to detect an output error of the optical signal. Since this method uses signals generated by a stage followed by the LD module 17 on a data flow, an error in the LD module 17, which is a final unit for inputting a signal to an optical line, cannot be correctly detected. If there is trouble in the output of the optical signal due to the error in the LD module 17, there is no method of correctly detecting the trouble and solving it. Furthermore, a method by which an error is detected by controlling the LD module 17 can detect only a limited number of errors.

### SUMMARY OF THE INVENTION

The present invention provides an optical network unit for error detection and recovery of an optical module, and a control method thereof, which directly detects an optical signal as a final output signal and a control signal of a burst mode optical module used in existing time division multiplexing (TDM), thereby solving problems caused by a TDM error.

According to an aspect of the present invention, an optical network unit (ONU) includes a passive optical network medium access control (PON MAC) to output an optical output control signal to activate a laser diode in a time slot allocated to the optical network unit, a monitor photo diode (PD) to sense whether the laser diode outputs an optical signal and generate a feedback signal and an error detection controller to determine whether optical signal output operation is abnormal by comparing the optical output control signal with the feedback optical signal.

According to an aspect of the present invention, the error detection controller determines that the optical signal output operation is abnormal when a feedback signal of the optical signal is received even though the optical output control signal is not applied. Further, the error detection controller determines that the optical signal output operation is abnormal when the optical output control signal is detected at a time not allocated to the optical network unit. In this case, the error detection controller stops outputting the optical signal by interrupting power supplied to an optical signal output module.

According to an aspect of the present invention, the optical network unit further includes an optical output detector that converts an analog optical signal feedback signal from the monitor photo diode into a logic signal and transmits the logic signal to the error detection controller.

According to another aspect of the present invention, a method of controlling an optical network unit, includes transmitting, by a passive optical network medium access control (PON MAC) unit, data together with an optical output control signal to an optical module, detecting, by a monitor photodiode, an optical signal output from a laser diode and feeding it back and receiving, by an error detection controller, the optical output control signal and the feedback signal of the optical signal to determine whether optical signal output operation is abnormal.

According to yet another aspect of the present invention, the determination of the error detection controller includes determining that the optical signal output operation is abnormal when a feedback signal of the optical signal is received even though the optical output control signal is not applied. Further, the determination of the error detection controller includes determining that the optical signal output operation is abnormal when the optical output control signal is detected at a time not allocated to the optical network unit. Thus, when the optical signal output operation is abnormal, the error detection controller stops outputting the optical signal by interrupting power supplied to an optical signal output module.

According to still another aspect of the present invention, the feedback of the monitor photodiode includes converting an analog optical signal from the monitor photo diode into a logic signal and transmitting the logic signal to the error detection controller.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of a general time-division multiplexing (TDM)-based optical network;

FIG. 2 is a block diagram illustrating a malfunction of a general TDM-based optical network;

FIG. 3 is a block diagram showing an interior configuration of a general TDM-based optical network unit;

FIG. 4 is a block diagram showing an optical network unit according to an exemplary embodiment of the present invention;

FIG. 5A is a block diagram showing an optical output unit where an optical output detector is disposed independently of a laser diode (LD) module and an LD driver;

FIG. 5B is a block diagram showing an optical output unit where an optical output detector is disposed inside an LD driver;

FIG. 6 is a flowchart illustrating a method of controlling an optical network unit according to an exemplary embodiment of the present invention; and

FIG. 7 is a flowchart illustrating a process of controlling an optical output unit in an error detection controller according to an exemplary embodiment of the present invention.

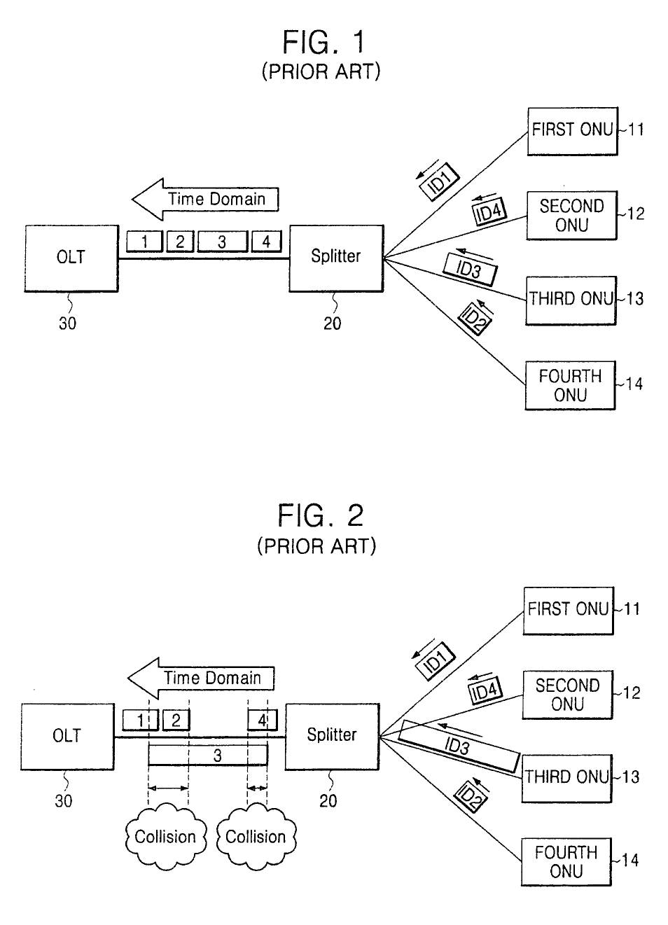

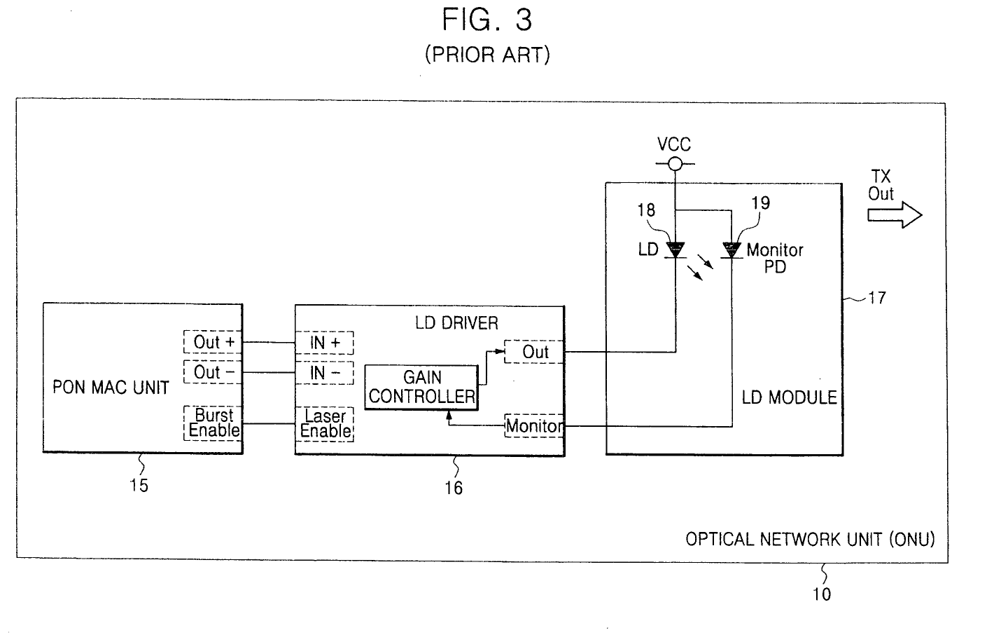

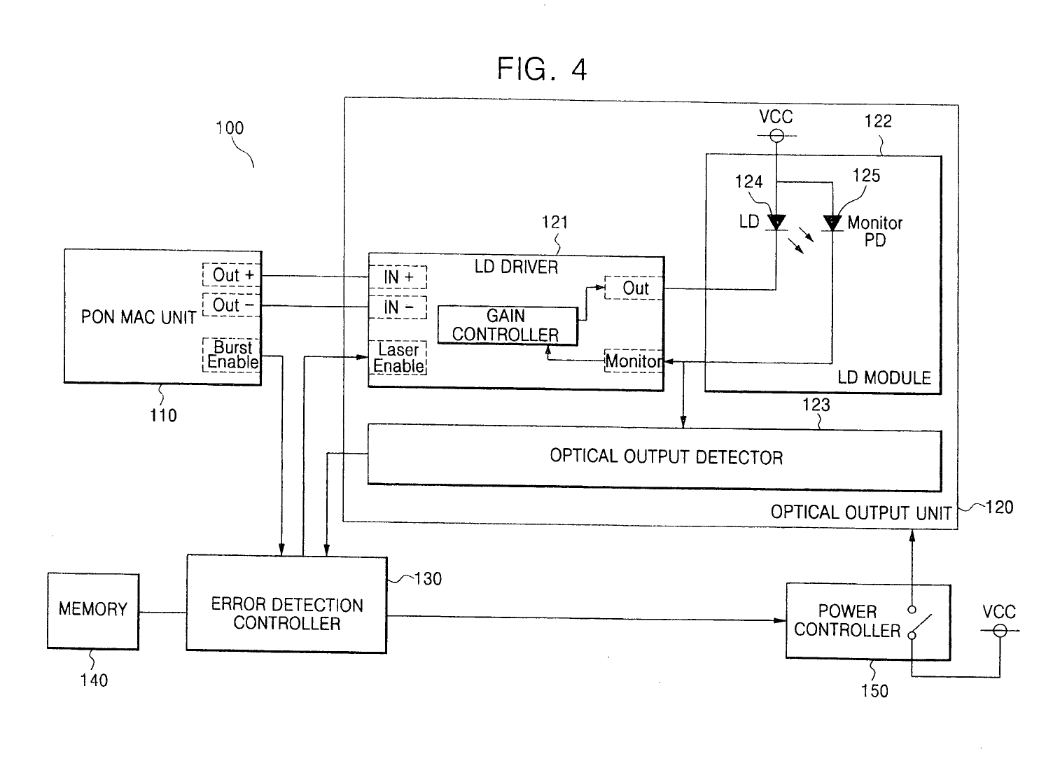

### DETAILED DESCRIPTION OF THE INVENTION

Hereinafter, exemplary embodiments of the present invention will be described in full detail with reference to the accompanying drawings An optical network unit for error detection and recovery of an optical module, and a control method thereof will now be described more fully hereinafter with reference to the accompanying drawings, in which exemplary embodiments of the invention are shown. However, the present invention may be embodied in many different forms and should not be construed as limited to the exemplary embodiments set forth herein. Hereinafter, like numerals refer to like elements throughout the specification.

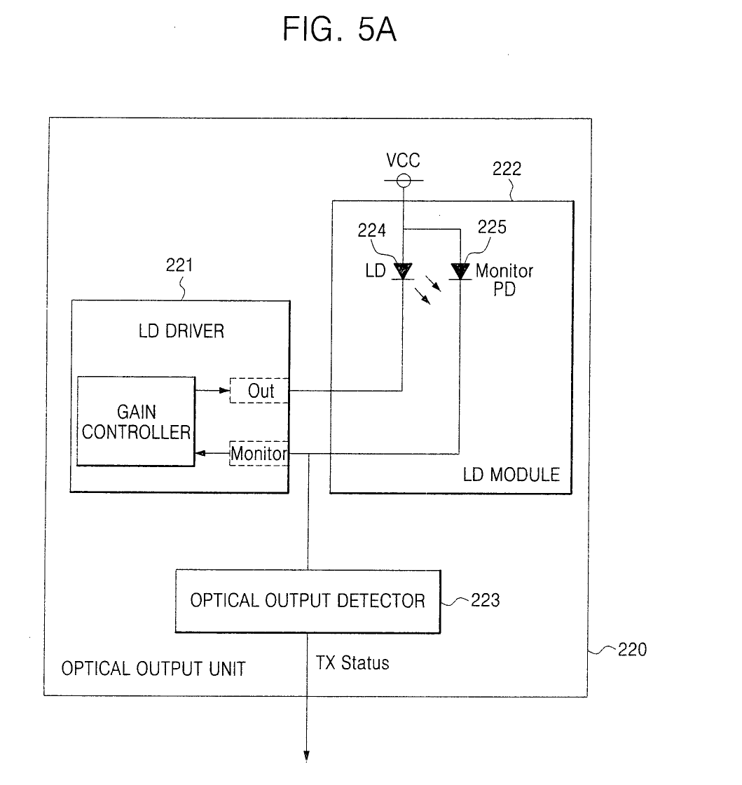

FIG. 4 is a block diagram showing an optical network unit according to an exemplary embodiment of the present invention.

As shown in FIG. 4, an optical network unit (ONU) 100 includes a passive optical network medium access control (PON MAC) unit 110, an optical output unit 120, an error detection controller 130, a memory 140, and a power controller 150.

The PON MAC unit 110 transmits data to the optical output unit 120 before transmitting it to an optical line termination (OLT). The ONU 100 according to this embodiment transmits an optical signal to the OLT using time division multiplexing (TDM). For this, the PON MAC unit 110 transmits an optical output control signal to output an optical signal to a burst enable terminal, to a laser diode (LD) driver 121 via the error detection controller 130.

The optical output unit 120 may include the LD driver 121, an LD module 122 and an optical output detector 123. Here, the LD module 122 may include an LD 124 and a monitor photo diode (PD) 125.

The LD driver 121 performs general control to drive the laser diode 124. The LD driver 121 receives the optical output control signal from the error detection controller 130 through a laser enable terminal. Further, the LD driver 121 receives a data signal through In+ and In− terminals from the PON MAC unit 110.

Upon receipt of the optical output control signal through the laser enable terminal, the LD driver 121 selects a control signal corresponding to the data signal received from the PON MAC unit 110. The control signal selected by the LD driver 121 is transmitted to the LD 124 of the LD module 122 through an output terminal, and the LD 124 generates a substantial optical signal according to the control signal.

The LD 124 generates the substantial optical signal according to the control signal received from the LD driver 121. The optical signal generated by the LD 124 is transmitted through a Tx terminal (not shown) or the like.

The monitor PD 125 detects the optical signal generated by the LD 124 and feeds the intensity of the optical signal from the LD 124 back to the LD driver 121. The LD driver 121 checks the intensity of the feedback optical signal, and performs a gain control reflecting the checked intensity, thereby obtaining the output of the optical signal having more correct intensity. Further, the monitor PD 125 of this embodiment transmits an output result of the feedback optical signal to the error detection controller 130.

In general, the monitor PD 125 transmits the output result of the optical signal as an analog signal to the LD driver 121. Here, the analog signal cannot be directly input to the error detection controller 130. Therefore, the optical output detector 123 receives the output result of the optical signal from the monitor PD 125, converts it into a logic signal, and transmits the logic signal to the error detection controller 130. The optical output detector 123 may be implemented by a transistor, a field effect transistor, a microprocessor using a digital signal processing algorithm, or the like.

The error detection controller 130 compares the optical output control signal from the PON MAC unit 110 with the output result of the optical signal from the monitor PD 125 to determine whether the optical output unit 120 operates normally.

If the optical output control signal is not identical with the output result of the optical signal, the error detection controller 130 determines that the optical output unit 120 operates erroneously. If the optical signal is output even though the optical output control signal is not applied, it means that the optical output unit 120 is not responsive to the optical output control signal from the PON MAC unit 110.

Meanwhile, when the optical output control signal received from the PON MAC unit 110 is transmitted at a disallowed time, the error detection controller 130 determines that the PON MAC unit 110 or a positive optical network physical layer (PON PHY) unit (not shown) of the PON MAC unit 110 is defective.

If such an error is generated continuously, the ONU 100 uplink-outputs an optical signal at a disallowed time. In this case, the ONU 100 collides with other ONUs that normally uplink-output the optical signals, so that the whole system may malfunction.

Accordingly, the error detection controller 130 interrupts the power supplied to the optical output unit 120 so as not to have an effect on other units sharing the optical line. Such control can be achieved by applying a power interruption control signal to the power controller 150 that supplies the power to the optical output unit 120. Further, a log indicating the error generation is stored in the memory 140, and afterwards is used for solving an error of the optical output unit 120.

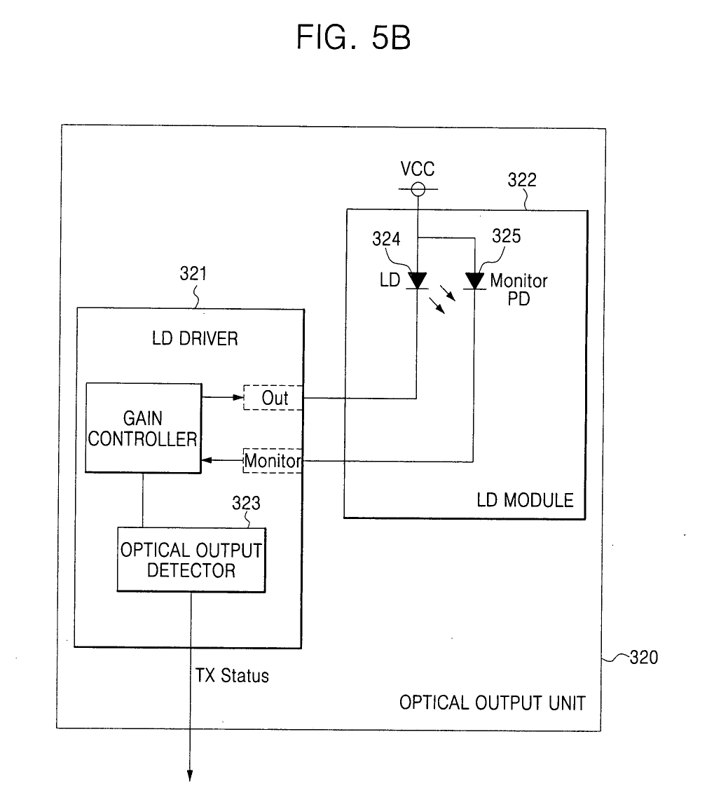

FIG. 5A is a block diagram showing an optical output unit where an optical output detector is disposed independently of an LD module and an LD drive, and FIG. 5B is a block diagram showing an optical output unit where an optical output detector is disposed inside an LD driver.

Where an optical output detector 223 is provided independently, as shown in FIG. 5A, an LD driver 221 and an LD module 222 that have been commercialized can be used. On the other hand, where an optical output detector 323 is embedded in the LD driver 321, more efficient signal processing is possible. However, since the configuration shown in FIG. 5B requires a new design of the LD driver 321, it is useful when the present invention is commercialized. However, it would be recognized that commercialized units are not necessary for the implementation of the instant invention.

The optical output detectors 223 and 323 are the same in that they employ monitor PDs 225 and 325 to check outputs from the LDs 224 and 324, respectively, and output a high signal when there is a output from a corresponding LDs 224 and 324, and output a low signal when there is no output from the LDs 224 and 324. Alternatively, the optical output detectors 223 and 323 may employ inverters to output a low signal when there is an output from the LDs 224 and 324 and output a high signal when there is no output from the LDs 224 and 324.

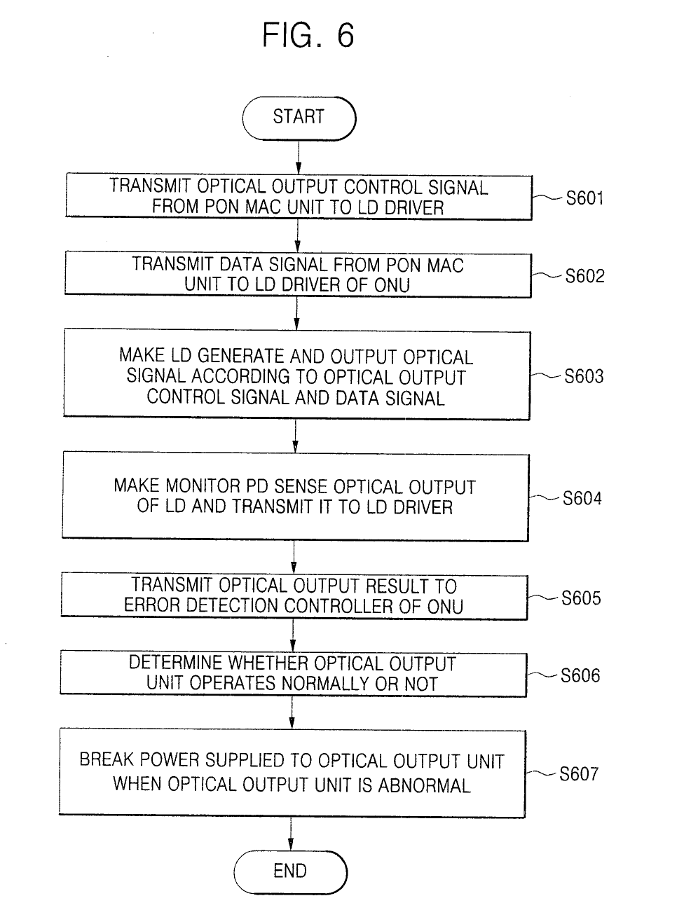

FIG. 6 is a flowchart illustrating a method of controlling an optical network unit according to exemplary embodiment of the present invention.

In step S601, a PON MAC unit or a PON PHY unit of an ONU outputs an optical output control signal to activate an LD in a time slot allocated to the ONU. The optical output control signal is transmitted to an LD driver and an error detection controller of the ONU.

In step S602, a PON MAC unit of the ONU transmits data to be uplink-transmitted to an OLT, together with the optical output control signal, to the LD driver.

In step S603, the LD driver of the ONU activates the LD so that the LD outputs an optical signal corresponding to the data received from the PON MAC unit or the PON PHY unit.

In step S604, a monitor PD of the ONU detects the optical signal output from the LD and feeds it back to the LD driver. The feedback signal is also transmitted to the error detection controller of the ONU (S605). Here, since the monitor PD generally outputs the output result of the optical signal as an analog signal to the LD driver, it may be necessary to convert the feedback signal to a logic signal and transmit the logic signal to the error detection controller.

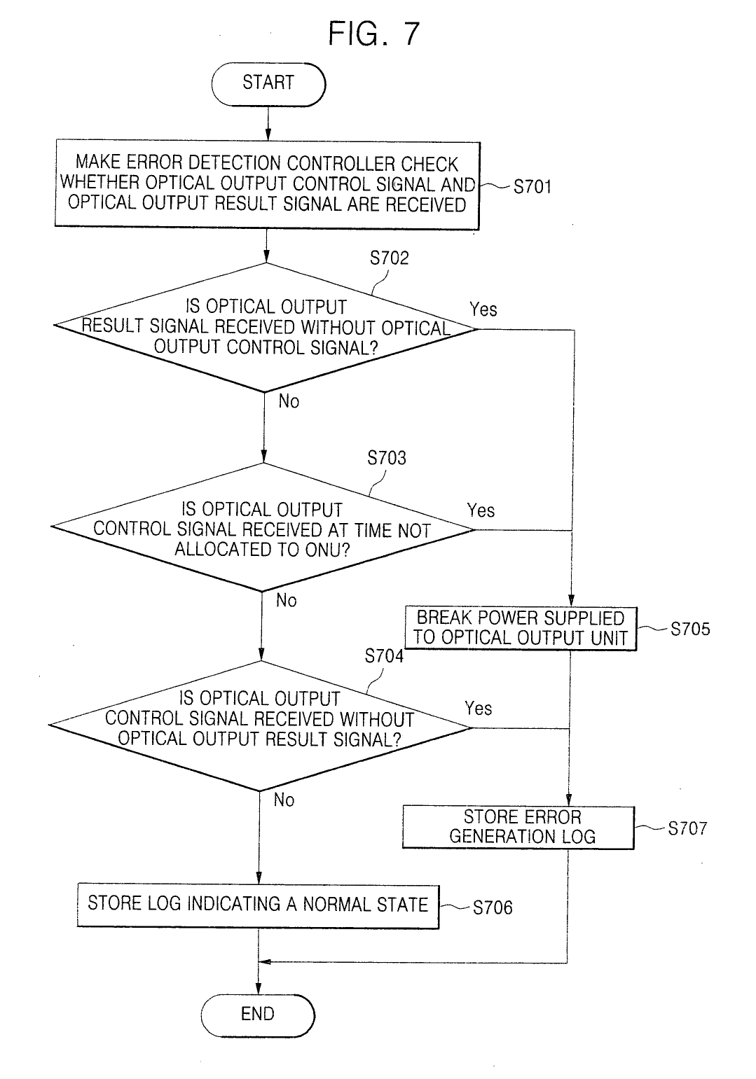

In step S606, the error detection controller determines whether the optical output unit operates normally the basis of the optical output control signal from the PON MAC unit and the optical output result signal from the monitor PD. The error detection controller will be described with reference to FIG. 7.

In step S607, when the optical output unit operates abnormally, the error detection controller interrupts the power supplied to the optical output unit in order to avoid collision with uplink-transmissions of other ONUs.

FIG. 7 is a flowchart illustrating a process of controlling an optical output unit in an error detection controller according to an exemplary embodiment of the present invention.

In step S701, the error detection controller checks whether an optical output control signal and an optical output result signal are received.

In step S702, the. error detection controller determines whether the optical output control signal is not received but the optical output result signal is received. If the optical output result signal is received, i.e., Yes” determination in step S702, it indicates that the optical output unit outputs an optical signal even though there is no command to output the optical signal. The error detection controller thus interrupts the power supplied to the optical output unit in step S705. In step S707, an error generation history is stored in the log.

In step S703, the error detection controller also determines whether an optical output control signal is applied to the ONU in a time slot not allocated to the ONU. This shows that an error is generated in a PON MAC unit controlling an optical signal. Because such an error causes collision with other ONUs and interferes with the operation of the whole system, the error detection controller interrupts the power supplied to the optical output unit in step S705. In step S707, an error generation history is stored in the log.

Finally, the error detection controller determines whether the optical output control signal is received but the optical output result signal is not received in step S704. This means that the optical output unit did not output the optical signal even though it should have. This case also indicates that an error is generated in the ONU, but it has no effect on the uplink-transmission of other ONUs utilizing a TDM optical network. Accordingly, the error detection controller may store a log indicating error generation without interrupting the power supplied to the optical output unit in step S707.

If it is determined in the above three determining processes that the optical output operation is not abnormal, the error detection controller saves a log indicating a normal state in step S706. The process of determining whether the output operation is normal is not limited to once a single determination, as shown, but it may be repeatedly performed to continuously monitor the status of the network.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood by those skilled in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been described with reference to the exemplary embodiments, it should be understood to those skilled in the art that various other modifications and changes may be provided within the spirit and scope the present invention defined in the following claims.

What is claimed is:

1. An optical network unit (ONU) comprising:
an optical output unit comprising:
a laser diode;
a monitor photo diode (PD) for detecting an optical signal output from the laser diode and generating a feedback output signal;
a passive optical network medium access control (PON MAC) for outputting an optical output control signal to activate the laser diode in a time slot allocated to the optical network unit; and
an error detection controller for receiving the optical output control signal and the feedback output signal and determining whether optical signal output operation is abnormal dependent upon the status of the optical output control signal and the feedback output signal.

2. The optical network unit as claimed in claim 1, wherein the error detection controller determines that the optical signal output operation is abnormal when the feedback output signal is received when the optical output control signal is not.

3. The optical network unit as claimed in claim 2, wherein the error detection controller interrupts power supplied to the optical output unit.

4. The optical network unit as claimed in claim 1, wherein the error detection controller determines that the optical signal output operation is abnormal when the optical output control signal is detected at a time not allocated to the optical network unit.

5. The optical network unit as claimed in claim 4, wherein the error detection controller interrupts power supplied to the optical output unit.

6. The optical network unit as claimed in claim 1, further comprising:
an optical output detector for converting an analog feedback output signal from the monitor photo diode into a logic signal and transmitting the logic signal to the error detection controller.

7. A method of controlling an optical network unit, the method comprising the steps of:
transmitting, by a passive optical network medium access control (PON MAC) unit, data together with an optical output control signal to an optical module;
detecting, by a monitor photodiode, an optical signal output from a laser diode and generating a feedback signal; and
determining, by an error detection controller, whether optical signal output operation is abnormal based on the status of the optical output control signal and the feedback signal.

8. The method as claimed in claim 7, wherein the step of determining, comprises the steps of:
determining abnormal operation when the feedback signal is received and the optical output control signal is not.

9. The method as claimed in claim 8, further comprising the step of:
interrupting power supplied to an optical output unit comprising said laser diode and said monitor photodiode.

10. The method as claimed in claim 7, wherein the step of determining comprises the step of:
determining operation is abnormal when the optical output control signal is detected at a time not allocated to the optical network unit.

11. The method as claimed in claim 10, further comprising the step of:
interrupting power supplied to an optical output unit comprising said laser diode and said monitor photodiode.

12. The method as claimed in claim 7, wherein the step of detecting further comprises the step of:
converting an analog feedback signal from the monitor photo diode into a logic signal and transmitting the logic signal to the error detection controller.

13. A system for controlling the output of an optical network unit comprising:
a medium access control module providing a control signal for a known time slot;
an optical module unit comprising a laser diode and a photo-detector, the optical module unit receiving said control signal for activating a laser diode, and said photo-detector generating a feedback signal in response to light generated by said laser diode;
an error detector receiving said control signal and said feedback signal and generating a power control signal based on the received control signal and feedback signal; and
a power control module receiving said power control signal to interrupt power to said optical module unit.

14. The system of claim 13, wherein said power control signal is generated when only said feedback output signal is received.

15. The system of claim 13, wherein said power control signal is generated when said control signal is detected for a time greater than said know time slot.

16. The system of claim 13 further comprising:
an output detector receiving said feedback signal and converting said feedback signal into a digital form.

17. The system as claimed in claim 13, further comprising:
a memory in communication with said error detector for recording generation of said power control signal.
